(19) United States
(12) Patent Application Publication
(10) Pub. No.: US 2026/0119897 A1
(43) Pub. Date: Apr. 30, 2026

(54) CONTROLLABLE AGENTS WITH STYLE IN OPEN WORLD GAMES THROUGH PARAMETERIZED REWARD WEIGHT UNIVERSAL VALUE FUNCTION APPROXIMATORS

(71) Applicant: SONY GROUP CORPORATION, Tokyo (JP)

(72) Inventors: Roberto Capobianco, Rome (IT); Neil Burch, Edmonton (CA); Francesco Riccio, Aarau (CH); Josh Davidson, Edmonton (CA); Dustin Morrill, Edmonton (CA); Declan Oller, Somerville, MA (US); Peter Wurman, Acton, MA (US)

(21) Appl. No.: 18/928,993

(22) Filed: Oct. 28, 2024

(51) Int. Cl. G06N 3/092; A63F 13/63; A63F 13/67; A63F 13/69

(52) U.S. Cl. CPC G06N 3/092; A63F 13/63; A63F 13/67; A63F 13/69; A63F 2300/308

(57) ABSTRACT

A single policy can be trained to handle the user selection of parameters across a predetermined range for each component of an artificial intelligent agent within a domain. The agent can be trained across a number of weights within the desired range for each component. These weights determine how much of a reward portion for each component should be considered by the agent during training. Thus, an improved formulation can be realized for UVFA-like goals based on compositional reward functions parameterized by their components' weights. Additionally, a set of reward components has been determined for the domain of autonomous racing games that, when combined with the improved UVFA formulation, allows training a single racing agent that generalizes over continuous behaviors in multiple dimensions. This can be used by game designers to tune the skill and personality of a trained agent.

### BACKGROUND OF THE INVENTION

### 1. Field of the Invention

Embodiments of the invention relate generally to systems and methods of reinforcement learning. More particularly, embodiments of the invention relate to methods and systems for universal value function approximators (UVFA)-like goals based on compositional reward functions parameterized by their components' weights.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In the field of Reinforcement Learning, value functions V^{π} (s) are used to model the expected future reward for an agent starting in a state s and following a policy π. These value functions serve a dual purpose: guiding action selection directly or refining the learning process of a distinct policy function, particularly within the actor-critic framework.

Universal value function approximators (UVFA), V^{π} (s, g), are an extension of value functions that are additionally conditioned on a goal g, i.e., they estimate the future rewards starting from state s with the reward function depending on the active goal g. This augmentation allows a UVFA-based agent to attain proficiency across diverse objectives and potentially generalize learning to novel, unencountered goals. Exemplary goals for UVFA include a discrete set of goal states (e.g., 2D goal positions in a grid world with the agent rewarded for reaching the active goal position); or abstract representations like vectorized forms of arbitrary pseudo-reward functions.

In view of the foregoing, there is a need for improved formulation for UVFA-like goals based on compositional reward functions parameterized by their components' weights

### SUMMARY OF THE INVENTION

Aspects of the present invention provide an improved formulation for UVFA-like goals based on a weighted composition of parametric reward functions.

Additionally, aspects of the present invention introduce (1) a new way for humans to change agents' behaviors and styles through some control knobs available through some interface (e.g., sliders, code, vocal commands, or the like) and (2) a set of reward components for achieving style in open-world games. When combined with the new UVFA formulation, this allows training a single agent that can play the game scenario in multiple ways or styles that can be controlled by a human through a slider. This can be used by players or game designers to tune the personality and style of a trained agent.

Embodiments of the present invention provide a method and a non-transitory computer readable storage medium tangibly embodying a computer readable program code having computer readable instructions that, when executed, causes a computer device to carry out the method of training an artificial intelligent agent based on a weighted composition of parametric reward functions, wherein the method comprises defining a reward function based on a state and an action as a linear combination of a plurality of parameterized reward functions and a weight for each parameter of the plurality of parameterized reward functions; sampling multiple dimensions of the weight and the parameter for each of the plurality of parameterized reward functions from either a continuous or a discrete distribution; and training a single policy of the artificial intelligent agent over a continuous goal space including the plurality of parameterized reward functions represented by the continuous distribution of the weight and the parameter for each of the plurality of parameterized reward functions.

In some embodiments, the method further comprises improving a performance of the artificial intelligent agent over a segment of the continuous distribution of the weight by providing a skewed distribution of weight, wherein the training is performed over the skewed distribution of weight for one or more of the plurality of component reward functions.

In some embodiments, the skewed distribution of weight is a log-uniform distribution.

In some embodiments, the method further comprises sampling the distribution of weights and parameters once per training rollout at a beginning of an episode.

In some embodiments, the method further comprises repeatedly re-sampling the continuous distribution of weights and parameters during a training rollout, wherein the artificial intelligent agent becomes robust to reward function changes during ongoing trajectories.

In some embodiments, the method further comprises applying the continuous distribution of weights and parameters to both a policy and a value function of a training algorithm.

In some embodiments, the method further comprises updating a neural network policy from π(s) to π(s, w*, θ*) and the action-value function Q(s, a) to Q(s, a, w*, θ*) by concatenating the continuous distribution of weights, w* and parameters θ* with inputs related to a state, s. The parameter θ* is used since we need a reasonable example that is a feature of the interaction, but is not normally a feature of the world or a reward term. For example, θ* can be used to model driver fatigue in a racing game. The game code could change the value of the θ* term controlling fatigue the longer the driver drove. This does not change the reward term, but provides some non-observable element of the world to change.

In some embodiments, the method further comprises evaluating the single policy of the artificial intelligent agent at inference time by choosing a chosen weight and a chosen parameter for each of the plurality of parameterized reward functions, wherein the artificial intelligent agent behaves accordingly under a chosen reward function without any retraining.

In some embodiments, the artificial intelligent agent operates in an open world game environment.

In some embodiments, the plurality of parameterized reward functions include at least one of the following: (a) a reward part for the artificial agent to perform specific moves, including parameters including which move to perform and under which physical constraints or speed; (b) a reward part for the artificial agent to use specific weapons, including parameters including which weapon; (c) a reward part for the artificial agent to use a specific gadget, including parameters including which gadget; (d) a reward part for achieving specific secondary objectives, including parameters including which secondary objectives and which constraints to use; (c) a reward part for hitting specific button combinations, including parameters related to the combination itself and how many times the combination must be hit; (f) a reward part for hitting specific enemy parts, including parameters related to the enemy part itself; (g) a reward part for choosing a specific game strategy; (h) a reward part for a level of risk-taking; (i) a reward part for a speed of the artificial agent in task execution, including parameters such as a desired speed; and (j) a reward part of a traversal control, including physical constraints.

In some embodiments, each of the plurality of parameterized reward functions are defined within the single policy of the artificial intelligent agent.

In some embodiments, the method further comprises interconnecting the artificial agent with an interface operable to enable a user to specify parameters of the artificial agent.

In some embodiments, the interface includes at least one of a slider, a drop-down menu, a button, a voice input and a numerical input.

Embodiments of the present invention provide a method for providing an artificial intelligent agent in an open world game that is tunable to one or more weighted style components comprising defining a reward function based on a state and an action as a linear combination of a plurality of parameterized reward functions and a weight for each parameter of the plurality of parameterized reward functions; sampling multiple dimensions of the weight and the parameter for each of the plurality of parameterized reward functions from either a continuous or a discrete distribution; and training a single policy of the artificial intelligent agent over a continuous goal space including the plurality of parameterized reward functions represented by the continuous distribution of the weight and the parameter for each of the plurality of parameterized reward functions, wherein an input is provided to permit a user to tune a personality and a style of the artificial intelligent agent trained on the single policy.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates input modifications of the actor network of an exemplary soft actor-critic (SAC) algorithm to inform the agent on reward weights, according to an illustrative embodiment, using a subset of non-fixed dimensions of scalar component weights, w, and parameters, θ, as w* and θ*;

FIG. 2 illustrates input modifications of the critic network of an exemplary quantile regression soft actor-critic (SAC) algorithm to inform the agent on reward weights, according to an illustrative embodiment, using a subset of non-fixed dimensions of scalar component weights, w, and parameters, θ, as w* and θ*;

FIG. 3 illustrates an example of a simple slider interface with continuous, discrete or switch sliders that represent the different parameters available to the agent in a combat scenario for an open-world game, according to an illustrative embodiment; and

FIG. 4 provides a functional block diagram illustration of a computer hardware platform that can be used to implement a particularly configured computing device that can host an AI agent training engine.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods to develop artificial intelligence (AI) policies for artificial agents for various domains, including open world domains. The behavior of such AI agents can be user selected at run time by selecting parameters for a plurality of different factors. A single policy can be trained to handle the user selection of parameters across a predetermined range for each component. The agents can be trained across a number of weights within the desired range for each component. These weights determine how much of a reward portion for each component should be considered by the agent during training. Thus, an improved formulation can be realized for UVFA-like goals based on compositional reward functions parameterized by their components' weights. Additionally, a set of reward components has been determined for the domain of open world games that, when combined with the improved UVFA formulation, allows training a single agent that generalizes over continuous behaviors in multiple dimensions. This can be used by game designers to tune the style, skill and personality of a trained agent.

When AI policies are developed for different games, different players are playing with different skill levels. Thus, when playing against an AI agent, a player often desires this agent to play at a desired style or skill level. Aspects of the present invention provide reinforcement learning training processes to define what playing at different levels mean, where behaviors can be tuned by using an AI approach.

As discussed in greater detail below, aspects of the present invention provide the ability to train an agent across a plurality of weights for various parameters of the domain, such as an open world game domain, where the weight becomes an input to the neural network, so that the weights and parameters can be chosen at run time by the user. In some embodiments, the weighting and parameters can be provided as an input to both the policy and the Q-function. While inputting the weighting and parameters into the Q-function is not required in all aspects of the present invention, such an input may help achieve the learning during the training in a more stable fashion.

In some embodiments, the agent is trained in a training step so that the user can select weights and parameters during game play. In other embodiments, the agent may also be trained during game play as well, where the user can pick weights and parameters for game play and these results can be fed back into neural network to update the policy as needed.

### Goal & Reward Representation

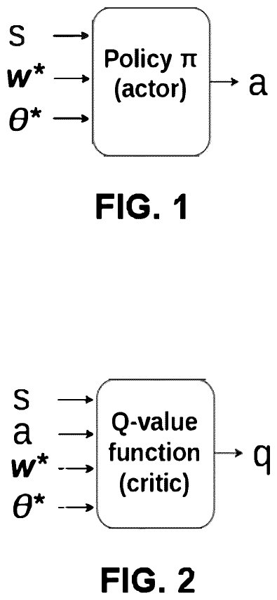

Referring to FIGS. 1 and 2, an environment's reward function R can be defined based on state s and action a as a linear combination of m components, as is done in many, if not most, Reinforcement Learning (RL) applications:

$$R ( s , a , w , θ ) := {\sum }_{i = 1}^{m} {w}_{i} {R}_{i} ( s , a , {θ}_{i} )$$

where wᵢ is a scalar component weight and Rᵢ(s, a, θᵢ) is the reward function for the i-th component with some specified parameters θᵢ. Usually RL applications keep w and θ fixed, and often search for the ones that are best suited for their application over multiple experiments.

Aspects of the present invention, however, can train an agent over a continuous goal space that includes parametrized reward functions represented by their weights and parameters. Instead of keeping w and θ fixed, aspects of the present invention sample along multiple dimensions i of w and θ from either a continuous or discrete distribution. This subset of non-fixed dimensions of w and θ is denoted as w* and θ* respectively.

It should be noted that, for sampling, any distribution can be used, including, but not limited to, uniform and skewed distributions, discrete and affine sets. Sampling can occur once per training rollout at the beginning of the episode (i.e., staying fixed thereafter), or after a fixed amount of episode steps. To inform the trained agent of the reward function it is operating under, aspects of the present invention provide both w* and θ* as additional input to both the policy (actor) and value functions (critic) of the training algorithm, as illustrated in FIGS. 1 and 2.

More specifically, aspects of the present invention expand the policy π(s) and action-value function Q(s, a) by alternatively (1) directly concatenating the reward component weights and parameters with the rest of the inputs, thus obtaining a policy π(s, w*, θ*) and an action-value function Q(s, a, w*, θ*); or (2) inputting the reward component weights and parameters to a representation function (typically a neural network), possibly shared between actor and critic, that generates a compressed representation of the goal space, and then concatenating such representation with the rest of the inputs. In this case a policy π(s, φ(w*, θ*)) and an action-value function Q(s, a, φ′(w*, θ*)) are obtained, where q and q′ could possibly coincide.

With additional parameters w* and θ* on both the policy and action-value function, the training loss changes as well. More in detail, the critic training loss now becomes a function of both the state-action pairs (s, a) and the new parameters, and can be mathematically represented as L_{critic} (s, a, w*, θ*). The addition of w* and θ* to the critic loss function influences the learning process by adjusting how the critic parameters (such as, the neural network weights) are updated during training to better estimate the value function. Similarly, their incorporation into the actor loss L_{actor} (s, w*, θ*) function influences the training dynamics, affecting how the actor parameters are updated during optimization to enhance action selection. Intuitively, the actor will learn to not only map states to actions, but also reward parameters and component weights. As a result, changing them will result in the choice of different actions.

### Agent Behavior Controllability

Controllability at runtime in reinforcement learning refers to the ability to influence the behavior of an agent while it is interacting with the environment and making decisions. Unlike traditional control systems, where actions are directly dictated by external commands, RL agents make decisions based on learned policies, often making controllability more nuanced.

Here, aspects of the present invention propose a solution that exploits the previously described representation. Specifically, when evaluating the agent's policy at inference time, w* and θ* can be set to any of the weights and parameters covered during training, and thanks to neural network generalization, also to unseen ones. According to the specified values, the agent will adapt its behavior and strive to behave optimally under the represented reward function without any retraining. Thus, at runtime and within the same episode or trajectory, the agent behavior can be controlled, i.e., its behavior can be changed by simply mutating w* and θ*.

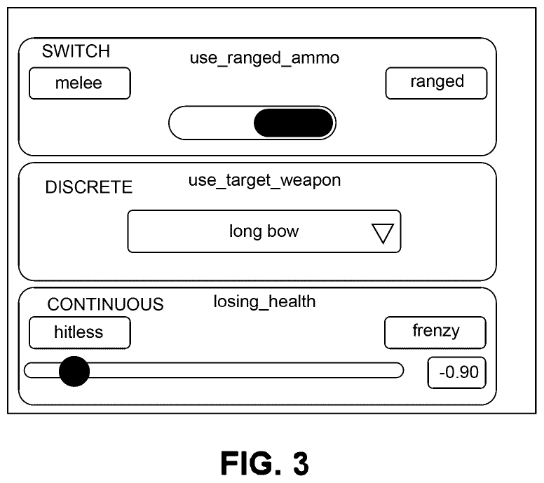

In order to enable controllability at runtime, the agent can be directly interconnected with some interface that enables the specification of such parameters. Such interface can be implemented in many ways, including but not limited to sliders, drop-down menus and numerical inputs, scripts, or button combinations, vocal or gesture-based interfaces. All of those can change the weights based on environmental conditions, verbal commands, user-interface elements in the game itself, rules created by the game designer, and the like. FIG. 3 shows an example of a simple slider interface with continuous, discrete or switch sliders that represent the different parameters available to the agent in a combat scenario for an open-world game.

### Reward Parts to Influence Styles in Open-World Games

Aspects of the present invention provide a set of parametric reward parts that can be used in combination with the previously defined formulation for open-world games. Those reward parts allow the encoding of different desired behavior types into the reward function. More in detail, the following reward parts may be provided: (1) A reward part for the agent to perform specific moves, such as punch or jump, including parameters such as which move to perform and under which physical constraints or speed; (2) A reward part for the agent to use specific weapons, including parameters such as which weapon; (3) A reward part for the agent to use specific gadget, including parameters such as which gadget; (4) A reward part for achieving specific secondary objectives, such as with a specified move including parameters such as which secondary objectives and which constraints to use; (5) A reward part for hitting specific button combinations, including parameters related to the combination itself and how many times the combination must be hit; (6) A reward part for hitting specific enemy parts, including parameters related to the enemy part itself; (7) A reward part for choosing specific game strategy (e.g., stealth, aggressive, melee, or the like); (8) A reward part for the level of risk-taking; (9) A reward part for speed of the agent in task execution, including parameters such as desired speed; and (10) A reward part of traversal control, including physical constraints, such as areas to hit or to avoid, as well as preferred elevation, or the like. Of course, the above represents only examples of reward parts to allow the encoding of different desired behavior types into the reward function.

Advantages of Controllable Agents with Style in Open World Games

Using the proposed approach, according to aspects of the present invention, post-training (i.e., at inference time), a generic user can perform the following exemplary tasks: (1) Control agent moves by specifying preferences for specific actions (e.g., punch or jump); (2) Control agent speed in the completing game tasks, such as traversing from point A to B or clearing a combat scenario; (3) Control agent willingness to take risk; (4) Control agent selection of advanced skills by specifying preferences for specific skills; (5) Control agent achievement of secondary objectives by also specifying which secondary objective to achieve; (6) Control agent weapon selection, by also specifying which weapon to select; (7) Control agent gadget selection, by also specifying which gadget to select; (8) Control agent strategy choice, by specifying preferred strategy; (9) Design non-player characters (NPCs) that play according to user specified preferences; (10) Design NPCs that change strategy at runtime/playtime; (11) Enable game designers to create NPCs that can have styles that can be controlled by the player at playtime; (12) Improve exploration of agents by exploring under varying reward weights; (13) Turn on user-specified behaviors associated to specific button combinations as an accessibility feature; (14) Design different agent personalities and styles; and (15) Design controllable agents with the user preferred interface for game QA. It should be understood that many of these tasks, such as (1) through (8) above, can be changed by the user at run/play time.

While the above disclosure focuses on the domain of an open world game, it should be understood that aspects of the present invention may be applied to AI agents used in various different domains. For example, the AI agent may be one in an animation or locomotion domain, where, for example, one of the components may be provided to change the weight of an energy cost to create slower, faster or more expressive walking of the AI agent.

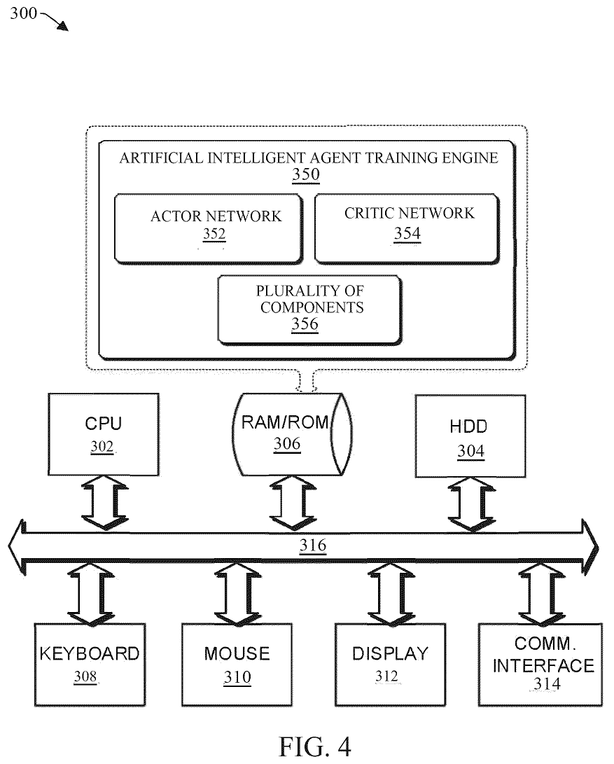

FIG. 4 provides a functional block diagram illustration of a computer hardware platform 300 that can be used to implement a particularly configured computing device that can host an AI agent training engine 350. The AI agent training engine 350, as discussed above, can include an actor network 352, an optional critic network 354 and a plurality of components 356 that can be each separately weighted for training an AI agent.

The computer platform 300 may include a central processing unit (CPU) 302, a hard disk drive (HDD) 304, random access memory (RAM) and/or read only memory (ROM) 306, a keyboard 308, a mouse 310, a display 312, and a communication interface 314, which are connected to a system bus 316.

In one embodiment, the HDD 304, has capabilities that include storing a

program that can execute various processes, such as the AI agent training engine 350, in a manner to perform the methods described herein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted 5 and also what incorporates the essential idea of the invention.

What is claimed is:

1. A method for training an artificial intelligent agent based on a weighted composition of parametric reward functions, the method comprising:
defining a reward function based on a state and an action as a linear combination of a plurality of parameterized reward functions and a weight for each parameter of the plurality of parameterized reward functions;
sampling multiple dimensions of the weight and the parameter for each of the plurality of parameterized reward functions from either a continuous or a discrete distribution; and
training a single policy of the artificial intelligent agent over a continuous goal space including the plurality of parameterized reward functions represented by the continuous distribution of the weight and the parameter for each of the plurality of parameterized reward functions.

2. The method of claim 1, further comprising improving a performance of the artificial intelligent agent over a segment of the continuous distribution of the weight by providing a skewed distribution of weight, wherein the training is performed over the skewed distribution of weight for one or more of the plurality of component reward functions.

3. The method of claim 2, wherein the skewed distribution of weight is a log-uniform distribution.

4. The method of claim 1, further comprising sampling the distribution of weights and parameters once per training rollout at a beginning of an episode.

5. The method of claim 1, further comprising repeatedly re-sampling the continuous distribution of weights and parameters during a training rollout, wherein the artificial intelligent agent becomes robust to reward function changes during ongoing trajectories.

6. The method of claim 1, further comprising applying the continuous distribution of weights and parameters to both a policy and a value function of a training algorithm.

7. The method of claim 6, further comprising updating a neural network policy from π(s) to π(s, w*, θ*) and the action-value function Q(s, a) to Q(s, a, w*, θ*) by concatenating the continuous distribution of weights, w* and parameters θ* with inputs related to a state, s.

8. The method of claim 1, further comprising evaluating the single policy of the artificial intelligent agent at inference time by choosing a chosen weight and a chosen parameter for each of the plurality of parameterized reward functions, wherein the artificial intelligent agent behaves accordingly under a chosen reward function without any retraining.

9. The method of claim 1, wherein the artificial intelligent agent operates in an open world game environment.

10. The method of claim 1, wherein the plurality of parameterized reward functions include at least one of the following:
(a) a reward part for the artificial agent to perform specific moves, including parameters including which move to perform and under which physical constraints or speed;
(b) a reward part for the artificial agent to use specific weapons, including parameters including which weapon;
(c) a reward part for the artificial agent to use a specific gadget, including parameters including which gadget;
(d) a reward part for achieving specific secondary objectives, including parameters including which secondary objectives and which constraints to use;
(e) a reward part for hitting specific button combinations, including parameters related to the combination itself and how many times the combination must be hit;
(f) a reward part for hitting specific enemy parts, including parameters related to the enemy part itself;
(g) a reward part for choosing a specific game strategy;
(h) a reward part for a level of risk-taking;
(i) a reward part for a speed of the artificial agent in task execution, including parameters such as a desired speed; and
(j) a reward part of a traversal control, including physical constraints.

11. The method of claim 10, wherein each of the plurality of parameterized reward functions are defined within the single policy of the artificial intelligent agent.

12. The method of claim 1, further comprising interconnecting the artificial agent with an interface operable to enable a user to specify parameters of the artificial agent.

13. The method of claim 12, wherein the interface includes at least one of a slider, a drop-down menu and a numerical input.

14. A method for providing an artificial intelligent agent in an open world game that is tunable to one or more weighted style components, the method comprising:
defining a reward function based on a state and an action as a linear combination of a plurality of parameterized reward functions and a weight for each parameter of the plurality of parameterized reward functions;
sampling multiple dimensions of the weight and the parameter for each of the plurality of parameterized reward functions from either a continuous or a discrete distribution; and
training a single policy of the artificial intelligent agent over a continuous goal space including the plurality of parameterized reward functions represented by the continuous distribution of the weight and the parameter for each of the plurality of parameterized reward functions, wherein an input is provided to permit a user to tune a personality and a style of the artificial intelligent agent trained on the single policy.

15. The method of claim 14, further comprising improving a performance of the artificial intelligent agent over a segment of the continuous distribution of the weight by providing a skewed distribution of weight, wherein the training is performed over the skewed distribution of weight for one or more of the plurality of component reward functions.

16. The method of claim 14, further comprising applying the continuous distribution of weights to both a policy and a value function of a training algorithm, wherein a neural network policy is updated from π(s) to π(s, w*, θ*) and the action-value function Q(s, a) to Q(s, a, w*, θ*) by concatenating the continuous distribution of weights, w* and parameters θ* with inputs related to a state, s and an action, a.

17. The method of claim 14, further comprising evaluating the single policy of the artificial intelligent agent at inference time by choosing a chosen weight and a chosen parameter for each of the plurality of parameterized reward functions, wherein the artificial intelligent agent behaves optimally under a chosen reward function without any retraining.

18. A non-transitory computer readable storage medium tangibly embodying a computer readable program code having computer readable instructions that, when executed, causes a computer device to carry out a method of training an artificial intelligent agent that generalizes over continuous behaviors in multiple dimensions, the method comprising:
defining a reward function based on a state and an action as a linear combination of a plurality of parameterized reward functions and a weight for each parameter of the plurality of parameterized reward functions;
sampling multiple dimensions of the weight and the parameter for each of the plurality of parameterized reward functions from either a continuous or a discrete distribution; and
training a single policy of the artificial intelligent agent over a continuous goal space including the plurality of parameterized reward functions represented by the continuous distribution of the weight and the parameter for each of the plurality of parameterized reward functions.

19. The method of claim 18, wherein the artificial intelligent agent is part of an open world game environment.

20. The method of claim 18, further comprising evaluating the single policy of the artificial intelligent agent at inference time by choosing a chosen weight and a chosen parameter for each of the plurality of parameterized reward functions, wherein the artificial intelligent agent behaves optimally under a chosen reward function without any retraining.
